(19) United States
(12) Patent Application Publication
(10) Pub. No.: US 2002/0192631 A1
(43) Pub. Date: Dec. 19, 2002

(54) Method and system for interactive teaching

(76) Inventors: Chase Weir, Washington, DC (US); Eric Zager, Seattle, WA (US); Stuart Egan, Roswell, GA (US)

Correspondence Address: CAHN & SAMUELS LLP, 2000 P STREET NW, SUITE 200, WASHINGTON, DC, 20036, US

(21) Appl. No.: 10/153,224

(22) Filed: May 23, 2002

Related U.S. Application Data
(60) Provisional application No. 60/292,522, filed on May 23, 2001.

(51) Int. Cl. G09B 3/00

(52) U.S. Cl. 434/350; 434/362; 434/169

(57) ABSTRACT

The invention preferably is a teaching and learning method and system for improving the educational process of students by increasing the interaction between student and teacher preferably. The system preferably includes at least one teacher console, at least one communications server, at least one student console, and at least one database.

This application claims the benefit of U.S. provisional Application Serial No. 60/292,522, filed May 23, 2001, which is hereby incorporated by reference.

### I. FIELD OF THE INVENTION

This invention relates to a method and system for teaching in an interactive manner between the teacher/instructor and a group of students. The invention more preferably relates to a method and system for analyzing information and data related to at least one group of students to, at least in part, predict trends and confirm that learning is progressing.

### II. BACKGROUND OF THE INVENTION

Various existing real-time group systems offer content delivery from large publisher parent corporations, test taking from bubble companies, opinion takers, and Trivia game show systems, and the selling of network infrastructure and related products in the name of real-time interaction. These systems all fail.

Notwithstanding the usefulness of the above-described methods, a need still exists for a method and system for interactive teaching.

### III. SUMMARY OF THE INVENTION

A real-time, wired or wireless classroom management system for education and training environments that includes multiple units for use by students, or group participants, a laptop, PC, or PDA unit for use by a teacher, trainer, or group leader, and a plurality of software modules and databases that store information input and output captured from and delivered to the student and teacher units. The management system combines attendance, test, participation, and ethnographic information into one database architecture and analysis engine. The teacher and student units communicate synchronously where data exchanges are instantaneously observable on system units, and data is automatically analyzed in a variety of complex ways to facilitate the learning process and in-class instruction. The classroom management system serves as the central repository for all classroom data needs, and is accessible by authorizations within the classroom or learning environment by all learning participants, or via a network outside of the classroom, or via the web anywhere by various users.

According to one aspect of the invention, the invention includes a system for educating students that includes at least one teacher console, at least one communications server connected to said at least one teacher console, at least one student console capable of connection to said at least one communications server, and a database in communication with said at least one teacher console and said at least one communications server.

According to one aspect of the invention, the invention includes a method method for educating students that includes requiring each student to login upon arrival for a class session, sending assessments from a teacher workstation to at least one student via a network, receiving at least one answer in response to a question included within the assessment while the student is completing the assessment, tracking the answers entered by the at least one student such that the answers can be displayed upon request from the teacher, and tracking the progression of each at least one student through the assessment such that the tracking information can be displayed upon request from the teacher.

An objective of the invention is to increase the level of participation by all students in a class. The increased participation will lead to increased attentiveness and thus a greater likelihood that the material will be understood by the students in the class.

Another objective of the invention is to allow for monitoring of the entire class's progress through an examination, test, quiz, etc. including the percent complete and accuracy of the answers to that point.

Given the following enabling description of the drawings, the apparatus should become evident to a person of ordinary skill in the art.

### IV. BRIEF DESCRIPTION OF THE DRAWINGS

The present invention is described with reference to the accompanying drawings. In the drawings, like reference numbers indicate identical or functionally similar elements.

FIG. 1 illustrates an overview of possible implementations of the invention.

FIGS. 2-4 depict block diagrams of different aspects of the invention.

FIGS. 5-67 illustrate different exemplary interfaces for use at the teacher console according to the invention.

FIGS. 68-84 depict different exemplary interfaces for use at the student consoles according to the invention.

FIGS. 85 and 86 illustrate a flowchart according to an aspect of the invention.

FIG. 87 depicts an alternative embodiment according to the invention.

FIG. 88 illustrates an alternative embodiment interface for the student consoles according to the invention.

### V. DETAILED DESCRIPTION OF THE DRAWINGS

The present invention is described more fully hereinafter with reference to the accompanying drawings, in which preferred and exemplary embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. The accompanying drawings show preferred and/or exemplary embodiments of the invention.

As will be appreciated by one of skill in the art, the present invention may be embodied as a computer implemented method, a programmed computer, a data processing system, a signal, and/or computer program. Accordingly, the present invention may take the form of an entirely hardware embodiment, an entirely software embodiment or an embodiment combining software and hardware aspects. Furthermore, the present invention may take the form of a computer program on a computer-usable storage medium having computer-usable program code embodied in the medium. Any suitable computer readable medium may be utilized including hard disks, CD-ROMs, optical storage devices, or other storage devices.

Computer program code for carrying out operations of the present invention is preferably written in a plurality of languages, for example, including PASCAL and C++. However, consistent with the invention, the computer program code for carrying out operations of the present invention may also be written in other conventional procedural programming languages.

The present invention is described below with reference to flowchart illustrations of methods, apparatus (systems) and computer programs in accordance with the several embodiments of the invention. It will be understood that each block of the flowchart illustrations and block diagrams, and combinations of blocks in the flowchart illustrations and block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means or program code that implements the function specified in the flowchart block or blocks.

The computer program instructions may also be loaded, e.g., transmitted via a carrier wave, to a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

Various templates and the database(s) according to the present invention may be stored locally on a provider's stand-alone computer terminal (or individual workstations) such as a desktop computer, laptop computer, palmtop computer, tablet computer, or personal digital assistant (PDA) or the like. Exemplary stand-alone computers may include, but are not limited to, Apple®, Sun Microsystems®, IBM®, Dell®, or Windows®-compatible personal computers. Accordingly, the present invention may be carried out via a single computer system, such as a desktop computer or laptop computer.

According to a preferred embodiment, the database may be centrally stored within one or more computers accessible to multiple users. Accordingly, users may access the database through a private or public computer network in a conventional manner via wired or wireless communications. By maintaining the database in a central location, updates can be easily made to the database by a system administrator without having to access all of the machines in the network.

The system and apparatus embodiment of the invention preferably at its highest level includes a teacher console, a communications server, a database, and at least one student console; and more preferably, the system includes a plurality of student consoles as illustrated, for example, in FIG. 1. The teacher console preferably interacts through the communications server with at least one of the plurality of student consoles, and each of the student consoles preferably are able to interact with the teacher console through the communications server. The teacher console and the communications server preferably both interact and communicate with the database, while preferably the student consoles communicate with the database through the communications server.

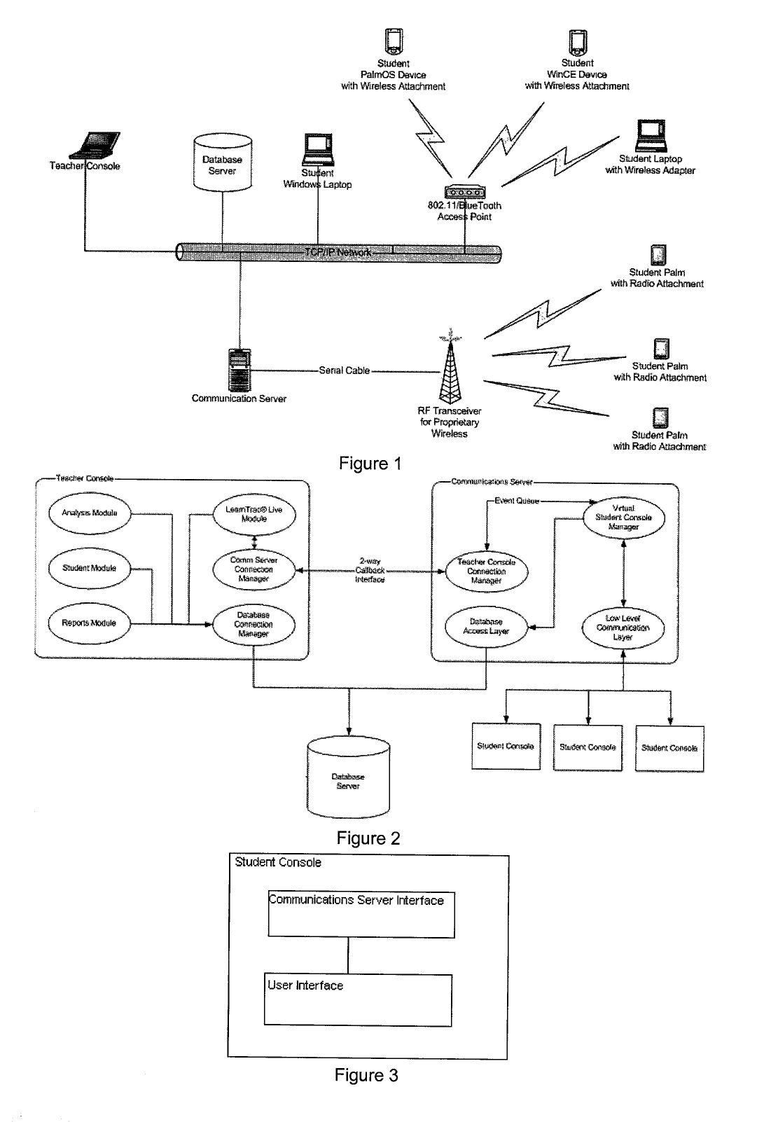

The teacher console preferably includes a database interface, a communications server interface, and at least one module as illustrated, for example, in FIG. 2. The at least one module preferably facilitates the education process by assisting the teacher with, for example, administrative tasks, analysis, and preparation of tests/quizzes. More preferably, the at least one module is made up of at least one submodule.

The communications server preferably includes a teacher console interface, a database interface, and a student console interface as illustrated, for example, in FIG. 2. The student console interface preferably includes a manager and a communications module. The manager preferably controls the operation of the communications server including the queuing of messages and communication packets traveling between the teacher and at least one student and/or between at least one student and the database. The communications module preferably facilitates communication with each of the student consoles both for transmitting and receiving information. The communications module preferably includes any hardware and/or software to create the communications link with each student console over a wireless, wired, infrared, or some combination of these connections. The database interface preferably controls the interaction between the teacher, students, and the database.

The student console preferably includes a communications server interface and a user interface as illustrated in FIG. 3. The communications server interface preferably interacts with the student console interface of the communications server.

The database preferably includes data relating to the education of the students by the teacher. The database preferably includes a server component to receive requests for information and send responses to the requests to the teacher console and the communications server, which preferably provides the interface for the students to the database as will be discussed and developed more fully later. More preferably, the database is reactive and not proactive in the management of data.

The preferred implementation of the system for a school is to have a plurality of teacher consoles, a communications server for each teacher console, a plurality of student consoles in communication with the communications server, and a database in communication with the teacher consoles and communications server as depicted in FIG. 1. Preferably, at least one teacher console may be used as an administrative station and thus would not need to have a communications server if it is dedicated to administrative tasks such as entering, for example, students, subjects, or courses.

A teacher console and communications server pair preferably is resident on the same workstation in implementation; however, these two components may be resident on different workstations connected together. In an implementation in one classroom of the system, the database may also be resident on the same workstation as the teacher console and/or the communications server; or alternatively the database may be located on a dedicated workstation, which preferably is the implementation for a multi-classroom setting. The communications server preferably communicates with the student consoles over a network, which may include wired and/or wireless aspects, as discussed above. The student consoles preferably are individual computers; more preferably the student consoles are PDAs to allow easy mobility between classes for students to be able to use a sole PDA for all courses.

Teacher Console

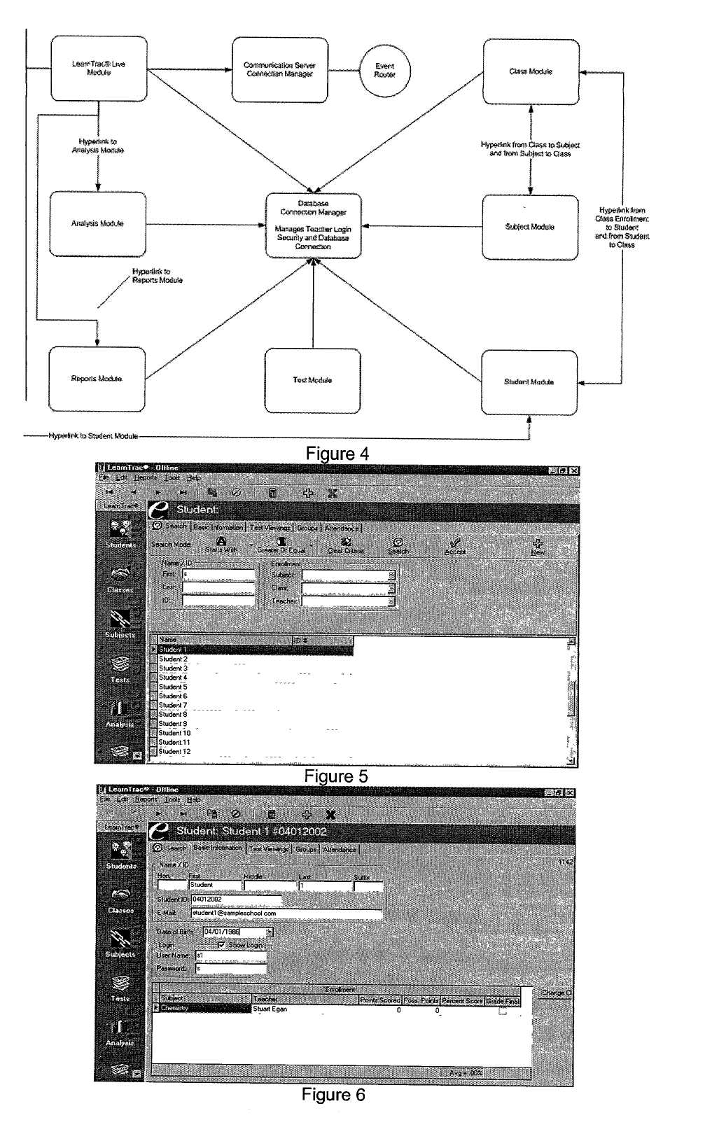

FIGS. 2 and 4 illustrate exemplary embodiments of the teacher console, which as mentioned above may be an administrative station for handling typical administrative tasks relating to the education process and thus the use of teacher will include administrator. The user interface preferably provides for the interaction with the system by the user including accessing the at least one module (or individual modules) that are included within a particular implementation of the system. As illustrated in FIG. 4, preferably the communications server interface includes an event router. The event router preferably notifies modules of important system events. Examples of important system events include student login, student logout, hand raise, new message, etc.

a. Exemplary Embodiment 1 for the Teacher Console

FIGS. 2 and 4-52 illustrate an exemplary embodiment of the teacher console component of the invention that will assist in defining the scope of the system and method.

The teacher console as depicted in FIGS. 2 and 4 includes the following modules: students, classes, subjects, tests, analysis, and reports. Preferably, each of these modules allows the teacher and/or an administrator to interact with the database and/or students to further the objectives of the educational system. The modules preferably accomplish this through at least one submodule that performs a particular function or a variety of functions including the handling and/or routing of information entered into the system. The submodules preferably control the database interface by directing it to pull and/or push certain information to the database preferably based upon selections and information entered by the user into a particular submodule. Each of the modules and submodules may be means for performing their respective functions.

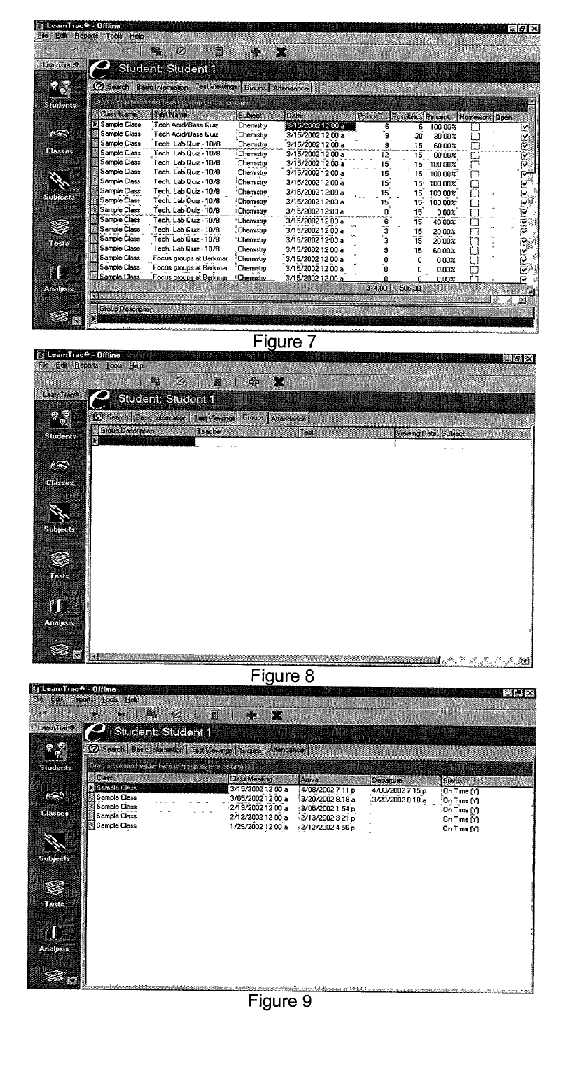

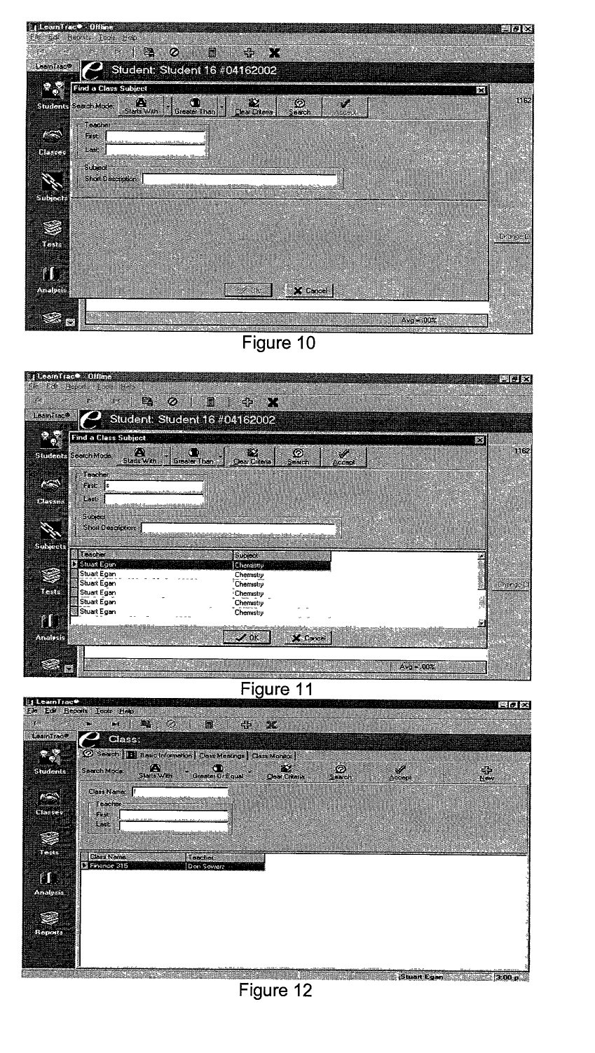

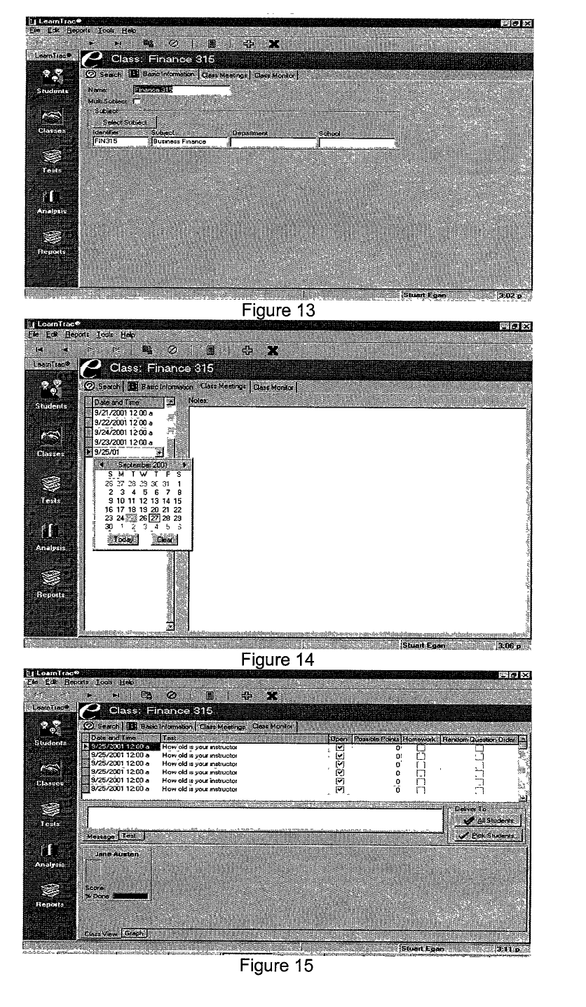

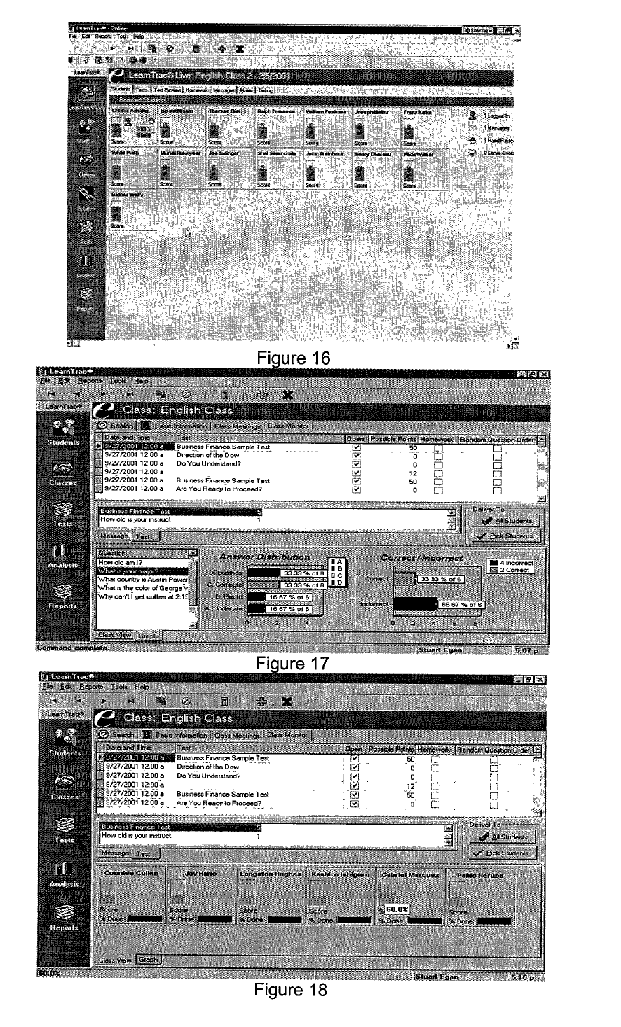

Preferably, the student module controls the information about a student as exemplified by interfaces shown in FIGS. 5-11. Examples of the type of student information includes ethnographic information, academic records including grades in current classes, groups/classes such as extracurricular activities or year in school, attendance in classes, and course schedule. The information about a particular student may be either manually entered student-by-student or alternatively, imported from an existing database into the database of the system. Preferably, students with similar extracurricular activities, course concentrations, or years of school are grouped together by assigning the students in these type of groups to those groups to allow, for example, for data analysis.

Preferably, the teacher will gain access to a particular student's information using a search function to expedite the locating of information relating to a particular student within the database like that illustrated in FIG. 5. More preferably, the teacher will be able to enter a portion of the student's name and/or other identification. An alternative embodiment is to allow the search to occur based upon a particular subject, course, and/or teacher as also illustrated in FIG. 5. The search results preferably are displayed in such a way to allow the teacher easy access to the information such as a list format allowing selection of a particular student.

Once the teacher selects a particular student, the student module preferably allows the teacher to review the information related to the student such as basic information, test results, group membership, and attendance. More preferably, this information is separated into portions such that the teacher may select a particular portion by selecting the respective tab. The student basic information preferably will include name, login information, and enrollment information as illustrated in FIG. 6. The student basic information may also include a student identification number, date of birth, and contact information such as an e-mail address. The login information preferably includes the student's login name and password information. The enrollment information preferably will include a list of subjects in which the student is enrolled in for a particular school term or alternatively all of the subjects the student has taken/is taking. For each subject, preferably the teacher and grade information will be provided. The grade information may, for example, include points scored, possible number of points, a percent score, and/or an indication as to whether the grade is final. An alternative embodiment adds a grade average for the subjects listed in the enrollment section.

The test results portion as illustrated in FIG. 7 preferably provides information relating to the assessments administrated to the particular student in the subject that is selected in the basic information portion. Preferably, the teacher is presented with information providing the class name, test name, subject, date, points scored, possible total points, and percent scored. The information may also include an indication whether the particular assessment will count towards a homework grade or test grade and whether the assessment is still outstanding with respect to other students within that class. An alternative embodiment adds a total points scored and total points possible, and may also include a total percentage score. A further alternative embodiment allows the teacher to list all of the assessments connected with a particular student or some subset such as for a particular course type like mathematics or science or date limited.

The group membership portion depicted in FIG. 8 preferably provides information relating to groups that the student has been assigned to based upon, for example, actual group membership or for analysis purposes.

The student attendance portion illustrated in FIG. 9 preferably provides information relating to whether the student has been on time, tardy, absent, or left early from a particular class session. Preferably, this information is automatically tracked by the system based upon when the student logs into and out of the system. Alternatively, the student attendance portion may also provide the actual time of arrival and departure as illustrated, for example, in FIG. 9.

Preferably, the student module will allow entry of new students into the system, for example, by selection of the new button or selection of a menu option as illustrated in FIGS. 10 and 11. The student module preferably upon receiving instructions from the user, the student module will provide a template for the user to complete regarding the new student as illustrated, for example, in FIG. 10. The student's course schedule preferably also is entered at this time within the enrollment section illustrated, for example, of FIG. 12. Preferably, the user will be provided with a search interface to assist in locating the particular courses that make up the student's schedule.

Preferably, the student module allows users to make changes to a student record to update and/or correct information that is contained in the database. This preferably is accomplished by performing a search for the student and then updating the student's information. Preferably, any of the information contained on the basic information portion may be updated. Alternatively, the student themselves may have the capability to edit their own information using this submodule from a student console.

The classes module as illustrated in FIGS. 12-20 preferably provides information relating to particular courses. The classes module preferably allows for the giving of assessments to the students along with notes, syllabus, and messages during a particular class session. Preferably, upon entry into the classes module, the teacher is presented with a search interface to assist in locating the particular class that the teacher wishes access in for review purposes or to teach as illustrated in FIG. 12. The search criteria preferably include class name and/or teacher name. Alternatively, the search criteria may be subject in place of and/or in addition to the preferred search criteria. The search results preferably are displayed in such a way to allow the teacher easy access to the information such as a list format allowing selection of a particular student. Preferably, the classes module provides information and interaction with the teacher with a basic information portion, a class meetings portion, and a class monitor portion.

The basic information portion as depicted in FIG. 13 preferably provides information relating to course identifier, subject, and department. The basic information portion may also provide information relating to the teacher and/or school from which the course is taught. Preferably, this is the portion from which a new course is added to the database by requesting a blank template form to be displayed for entry of the new course.

The class meetings portion preferably allows for entry and access to particular class session as illustrated in FIG. 14. Preferably, the system will automatically load into the database using user defined rules a schedule of class meetings for a period of time such as an entire term. Alternatively, individual class meetings may be entered manually by the teacher or other user. Prior to or at the beginning of a particular class meeting the teacher preferably will select the appropriate class meeting to allow the students to log into the system and have their attendance recorded within the database for the particular class meeting.

The class monitor portion preferably allows the teacher to administrate assessments, communicate with a particular student or students, and observe who is present for that class meeting via the interface. An exemplary interface to accomplish these functions is illustrated, for example, in FIG. 15. Preferably, the representation of the student will include space for the current score for the course to that point in the term, a flag as to whether the student is present in class, a flag to indicate whether the student has sent a message to the teacher, and a flag to indicate whether the student might have an answer to an oral question or a question to ask depending upon the context of the class. FIG. 16 provides an exemplary example of each of these flags for student Chinua Achebe. Preferably, upon selecting the message flag, the message will be displayed for the teacher. Both the message flag and the hand raised flag allow the student to interact with the teacher without the other students knowing about the interaction if both sides wish to maintain the veil of anonymity.

The class monitor portion preferably allows the teacher to ask a spontaneous question of all or a portion of the students. The objective is to increase the participation of the entire class. Preferably, once a message or question is sent from the teacher it will be displayed on the student console for review and/or response by the student. The class monitor portion preferably will forward the message to the communications server interface, which preferably will send it to the communications server for transmission to the selected student(s). As the student answers the question, then preferably the student console will forward the answer back through the communications server to the teacher console so that that teacher can see the answer from the respective student(s). Preferably, the teacher will be able to view the answer distribution and breakdown between correct/incorrect for the entire class as illustrated in FIG. 17. More preferably, the teacher will have the option to be able to also view the breakdown for a particular question by student; and more preferably, the level of completion of the question/assessment for each student will be displayed as illustrated in FIG. 18. Preferably, the teacher will be able to change between these views using tabs such as the Class View and Graph tabs shown in FIGS. 17 and 18. An alternative embodiment allows the teacher to have an assessment sent to the students with the questions in random order, which most preferably is such that adjacent students have receive the questions in different order, as illustrated in FIG. 19. Another alternative embodiment is to allow the teacher to designate the students who receive the questions/message as illustrated in FIG. 20.

The class monitor portion also preferably allows for assessments to be sent to the student consoles in a manner described above, for example, in connection with individual questions. Preferably, the same type of data will be available to be displayed in part because preferably as a student enters an answer to a question, the answer is sent to the teacher console.

An alternative embodiment will allow the teacher to access the analysis module by, for example, double clicking on a listed assessment.

Preferably, the subjects module allows for administration of the subjects being available for connecting to available courses within the database as depicted in FIGS. 21-24. Preferably, the subjects module provides portions relating to displaying/entry of subjects and attaching particular knowledge assessments such as learning standards to particular subjects. The subjects module is of particular usefulness for teachers who teach in more than one subject area and for users who attach curriculum standards and criteria to assessment measurements.

FIG. 21 illustrates a search portion for use as part of the subjects module. Preferably, the search portion allows for a search to be conducted based on, for example, a subject identifier, subject name, school or department. More preferably, the search portion allows for partial entry of search terms. Preferably, after a search is completed the matching subjects will be listed out such that the teacher may make a selection to view the basic information for a particular subject.

FIGS. 22 and 23 illustrate the basic information portion. The basic information portion preferably displays information relating to the subject such as the identifier, a short description or title, a long textual description, and/or a syllabus. When the teacher wants to enter a new subject, then the teacher preferably indicates such by selecting, for example, the plus sign (representing new) or using the menu system to receive a blank template to complete.

The knowledge assessment portion preferably allows the teacher to attach curriculum criteria of “Knowledge Assessments” to a subject/section. These standards for learning preferably will be attached to the subject and be available to the teacher when constructing assessment measures, for example, in the test module or analyzing student and class achievement, for example, in the analysis module. In the exemplary embodiment illustrated in FIG. 24, the short description field allows the teacher to enter in a descriptive account of the knowledge assessment, the document reference field allows the teacher to tag the knowledge assessment with a unique reference number, the area and sub area fields allow the teacher to further label the knowledge assessment by tagging the assessment criteria to a specific area of the curriculum, and the requirements field allows the teacher to attach a long description to the knowledge assessment. FIG. 24 illustrates these fields with information in them.

Preferably, the tests module preferably allows the teacher to create and edit all assessment measurements and set questions as illustrated in FIGS. 25-38. The term “assessment measures” is used to include all tests, quizzes, questionnaires and set questions.

FIG. 25 illustrates a search portion for use as part of the tests module. Preferably, the search portion allows for a search to be conducted based on, for example, a short name or a long name. More preferably, the search portion allows for partial entry of search terms. Preferably, after a search is completed the matching subjects will be listed out such that the teacher may make a selection to view the basic information for a particular subject.

The basic information portion preferably displays the short name, the long name, and any comments that might be associated with an assessment as exemplified in FIG. 26. The questions portion preferably displays the questions associated with the assessment being displayed in the basic information portion as exemplified in FIG. 27. The questions portion preferably provides the teacher the ability to add and/or edit questions associated with the assessment shown in the basic information portion. More preferably, the questions portion displays the list of questions including, for example, possible points, delivery method, and/or data type. When a question is highlighted, then preferably the question text, any comments, answers, and knowledge assessments are displayed.

When the teacher wishes to add or edit a question, preferably a wizard similar to that illustrated in FIGS. 28-37 will be displayed. The wizard preferably will assist the teacher in setting up the question including performing a search for any field in which the teacher may not have the information readily at hand to complete such as the subject field. Preferably, the wizard will include pull down menus for fields in which the number of options are easily managed in pull down menus. When the answer(s) is selected from a multiple choices, then preferably additional answer options are provided by selecting the down directional button after entry of an answer option. FIG. 33 displays an exemplary multiple choice question. The comments tab depicted in FIG. 34 preferably is for use by the teacher to associate any comments regarding the question with the question. The AKS tab depicted in FIGS. 35-37 preferably displays a wizard to attach a question with a criterion that must be covered within the course of instruction. When questions are tagged with a standard or criterion, then the teacher will be able to analyze how well the students are performing according to standards set for the curriculum using, for example, the analysis module. An exemplary way to activate the field on the AKS display is by clicking on the header Assessment Description. Preferably, the teacher will be able to obtain a list of standards and criteria connected with the subject area (as discussed above in connection with the subjects module) like that illustrated in FIG. 36. An exemplary way to accomplish this is by clicking on the arrow in FIG. 35. Preferably, the teacher will select one of the listed criterions by clicking on one in the list. FIG. 38 illustrates an exemplary question display showing one question. If the teacher wishes to include a questionnaire or set question, then the steps discussed above are repeated except the teacher does not indicate a correct answer.

Preferably, the analysis module and the reports module allow the teacher to evaluate the data regarding a particular course such that the education of the students is improved. More preferably, there are prebuilt analysis as depicted in FIG. 39 included within the analysis module. FIGS. 40-45 depict a variety of prebuilt analyses. FIGS. 46-52 illustrates the building of a comparison analysis using the analysis module wizard to se the parameters.

Preferably, when the teacher wishes to edit, delete, add, or other administrative tasks to information accessed through the teacher module, then these functions are provided using interface components that would be apparent to one of ordinary skill in the art in view of the present disclosure.

b. Exemplary Embodiment 2 for the Teacher Console

FIGS. 53-64 illustrate a second exemplary embodiment of the teacher console according to the invention. More particularly, different graphical user interfaces are illustrated that may be incorporated into the first exemplary embodiment. This exemplary embodiment includes a discussion about interfaces from the following modules: a subject module, a class module, a student module, a test module, and an analysis module. Preferably, when a module is selected it will display its interface in a window of the overall user interface that will include links to other items such as recent reports and analyses.

FIG. 53 illustrates an exemplary subject module interface that preferably would be available to administrators. The exemplary interface shows a portion of a list of subjects that preferably is in alphabetical order. The Applied Chem subject is expanded to list the courses associated with the subject along with the teacher and period for each course.

FIG. 54 illustrates an exemplary classes module interface. This exemplary interface illustrates that the classes may be listed in alphabetical order of the teacher's name; alternatively, the list may be presented in alphabetical order based upon description or sorted by period. Preferably, by selecting a particular course, the teacher will be presented with a display similar to that shown in FIG. 53 that shows a lesson book and various links to information that may be obtained from the database regarding that particular course. Through this module the teacher will be able to pull-up a gradebook similar to that illustrated in FIGS. 56 and 57. The exemplary interfaces also include tabs to pull information relating to attendance, summary, and a seating chart for a particular course. Preferably, the teacher will be able to expand the components of the grade out to further examine the performance of a student(s) as illustrated in FIG. 57.

The next module is the student module. The exemplary embodiment of the student module illustrated in FIG. 58 is similar to that of the subject and classes modules in that it provides a list of entries, which in this case is a list of students. The exemplary embodiment illustrates that a particular students course schedule can be included along with a grade average and number of absences for the student from a particular course. Preferably, each entry if clicked upon will pull up the underlying data for display to the teacher. For example, if a student's name is selected, then the teacher console might display the exemplary display of FIG. 59. Or if the grade for a particular class is selected, then the gradebooks of FIGS. 56 and 57 could be displayed.

FIGS. 60 and 61 illustrate a pair of exemplary wizards for use as part of the test module. These two wizards request information similar to that entered in connection with the test module of exemplary embodiment one above.

FIGS. 62-64 illustrate different examples of information that may be organized and displayed using the analysis module. Each of these exemplary interfaces allows the teacher to select the form of presentation including, for example, bar graphs, line graphs, pie charts, and textual grids. FIG. 62 illustrates a bar graph showing the averages for a series of assessments that includes tests, quizzes, and laboratories. Preferably, the type of assessment will be visually apparent based, for example, on the color of the bar. The student details button could display the gradebooks discussed above. The compare button preferably will allow a comparison of groups of students. The student report button preferably will display a summary of assessments and attendance for a particular term, i.e., a virtual report card. The advance analysis button preferably will take the teacher to an analysis wizard that will have the test and student criteria preselected based on the current display. If the teacher wishes to view information about a particular assessment, then the teacher may click on the appropriate bar to bring up that information.

FIG. 63 illustrates an example of a display to present the results for one assessment for the students in a particular course. If the teacher wishes to make a comparison with another assessment, then the teacher can do this by selecting the compare button and informing the system which other assessment is to be compared. FIG. 64 illustrates an example of such a comparison analysis between two tests for each student in a particular course. The test details button preferably will prompt an inquiry as to which assessment details are being requested and displaying the details for that particular assessment. The compare button will allow the teacher to add additional assessments to the comparison. The test report button preferably will prompt an inquiry as to which assessment a report is being requested and displaying a report for that particular assessment.

c. Exemplary Embodiment 3 for the Teacher Console

FIGS. 16 and 65 illustrate a pair of interfaces for use in the system. This exemplary embodiment preferably includes an overall interface from which the individual modules may be accessed. Both figures illustrate what the system looks like during a class session. FIG. 65 reflects the Tests tab view while FIG. 16 reflects the Students tab view.

The series of icons along the left side of the interface preferably are links to the other modules, in particular, Students, Classes, Subjects, Tests, Analysis, and Reports. These modules may be as described above or some combination of the above taken with the following description. Preferably, when the system is implemented the first module that is used is the Subjects module to set-up the different subjects that are going to be included within the system. Once the subjects are set-up, the classes are preferably set-up using the Classes module including correlating the classes to particular subjects. After setting up the classes available in the system database, then preferably students are entered into the database including there course schedule. After the subjects and classes are set-up, then the teachers can start to assemble tests and other assessments for use during class sessions. Preferably, the Students, Classes, Subjects, and Tests modules are utilized prior to a class session beginning; however, the system preferably allows the teacher to create questions on-the-fly by being provided, for example, a tab that will lead to a question wizard similar to (or the same as) the assessment wizard.

In the illustrated embodiment, the LearnTrac Live module is the module for use during a particular class session. The students tab view as illustrated in FIG. 16 preferably provides a view of the students in the class along with their respective score for the course, an indication of their presence, whether they have a message waiting for the teacher to review, whether they have a virtual hand raised, and an indication if there is a communication error with the connection between the teacher console and a particular student.

The tests tab view as illustrated in FIG. 65 preferably includes a window listing the assessments given up to that point in the course, and more preferably the list includes the possible points, whether the assessment is still outstanding for at least one student, a creation date, an assessment type (like test or quiz), and whether it has been graded. When an assessment is selected in the listing window preferably a list of questions (or identifiers for the questions) is provided for the assessment. Preferably when a particular question is selected, the possible answers are listed with a coding such as a color identifier to match with the answer representation for the students who have completed the assessment. Also, preferably there will be student representations that show the student's respective answer to the question with information relaying whether the answer was correct and the student's score on the entire assessment. More preferably, the respective answer will be coded to correlate to the possible answer list, which is particularly helpful for multiple choice questions including true/false questions. The teacher preferably can drill down further into the data and bring up a representation of the breakout in answers given to a particular question, for example, by double clicking on the question or selecting the Test Review tab. The Homework tab preferably will provide a similar view as the Tests tab except instead of information relating to assessments, the information will relate to homework assignments that have been given to the students.

The Messages tab preferably will bring up an interface that allows the teacher to view any messages that students have sent during the course of a class session. In this exemplary embodiment, if the teacher were to go to the Messages tab view there would be a message from Chinua Achebe.

The Notes tab preferably will bring up an interface that allows the teacher to distribute notes or other information relating to the course to selected students including the entire class. Examples of course information includes syllabus, schedule updates, outlines for what has been and/or will be covered during class, and student ethnographic information.

The Question tab preferably will bring up a wizard. The wizard preferably allows the teacher to ask a spontaneous question of the class or a particular student(s) during the course of a class session. Preferably, the question can be incorporated into determining the final grade for the course if the teacher desires for the inclusion of the question in the grade calculation. Alternatively, the question could be a check to see if the students are paying attention.

After a class session the Analysis and Reports modules become useful although both modules could be used during a class session. Both of these modules allow the teacher to correlate and mine the data regarding students contained in the database. Examples of possible correlation include finding trends and correlations between absences and incorrect answers on assessments and whether a particular student might have difficulty with a particular concept and/or type of question. Other possibilities include comparison between students in a class or between different sets of students such as different classes for the same course.

d. Exemplary Embodiment 4 for the Teacher Console

There preferably are four factors that need to be decided upon preferably to complete an analysis data from the database and include the following: who, when, what, and how. The who is who will be analyzed and the who could be, for example, a student, a class, a class session, a student group, a subject, a teacher, a school, a district, etc. The when is what time frame from which will the data be pulled for the analysis and could, for example, be a school year, school term such as a semester or quarter, a grading period, a class period, a date range, a single day, etc. The what is the category of information that is to be analyzed such as grades, response, attendance, etc. Examples of grades include tests, assignments, subject knowledge assessments, total student scores, total group scores, total class scores, etc. Examples of responses include instant questions, questionnaires, and assessment measurements. Examples of attendance include present, absent (excused or unexcused), tardy (excused or unexcused), or on time. The how is how should the information be presented such as in the form of a graph, table, report, etc.

Preferably, depending on how the who question is answered that will impact the options for the when question, which in turn will impact the options for the what question, and which in turn will impact the how question. Preferably, the reports option will allow the teacher to select the output, for example, in terms of a display, printer, email, website, or student PDA.

The analysis module preferably will have an assortment of predefined templates to display typically requested information associated with assessments to save the teacher from having to set-up the analysis. As discussed above, the teacher preferably will be able to create their own analysis based upon who, when, what, and how. Preferably, the analysis module will allow the teacher to build layers of analysis to create a complete analysis package.

The reports module preferably provides reports based upon information contained within the database based upon either templates or user preferences. Examples of standard reports include reports focused on students, student groups, classes, sections, and teacher. The reports could be delivered to the teacher console, a student console, a web application, or a central database. Delivery to the student console or a web application will allow the parents of the student to gain access to the report and alternatively will require acknowledgement of receipt of the report by at least one parent via password or other authenticity.

An example of a report that might be requested is a virtual report card as illustrated in FIG. 66.

The only limit to the level of analysis capable of being performed is the scope of the data contained within the database and/or data restrictions based upon who is accessing the information.

e. Alternative Embodiments for the Teacher Console

The following alternative embodiments may be incorporated into the above discussed exemplary embodiments.

One alternative embodiment is to include a feature to import data in large blocks from another database. This feature is of value for the initial implementation in a school that is maintaining an electronic database, because it avoids re-entry of the information by hand, which can lead to data entry errors.

Another alternative embodiment is to add a search feature to the modules that do not have a search feature as the search feature is discussed above.

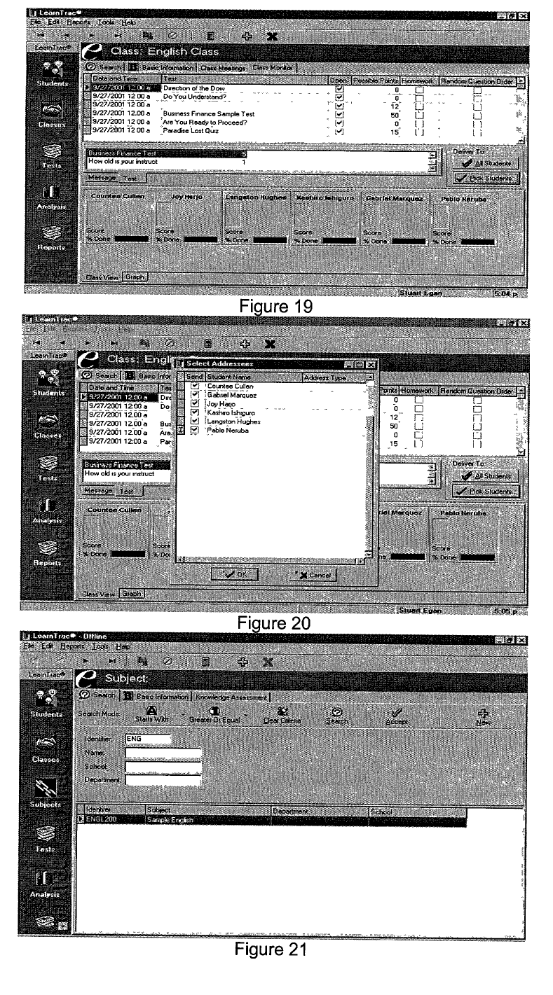

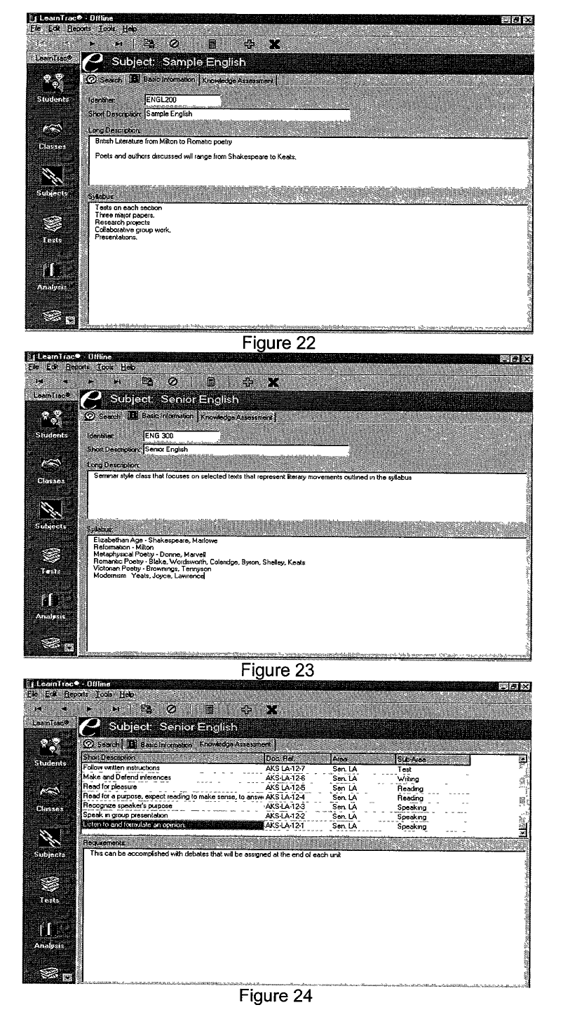

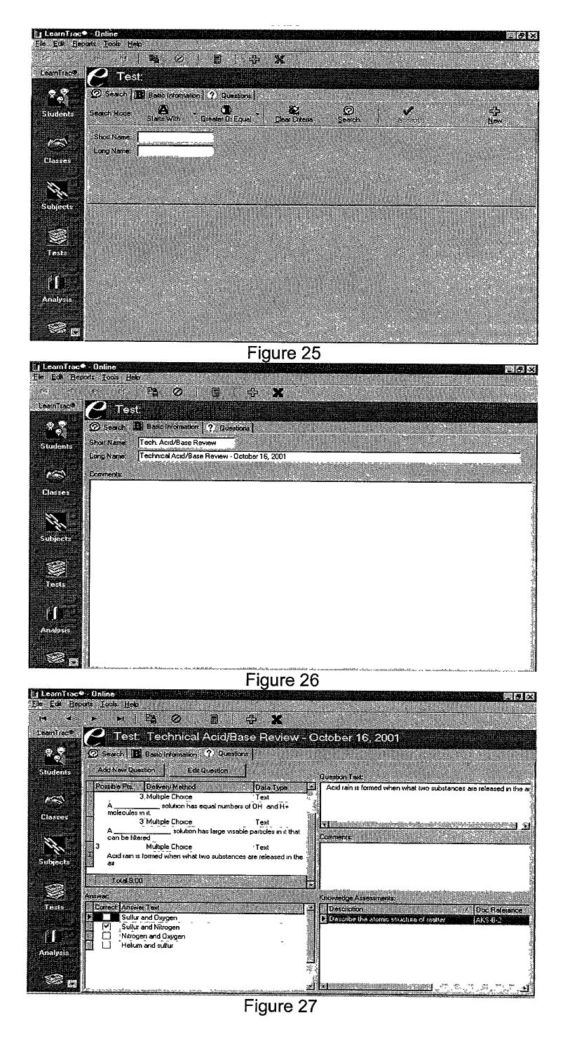

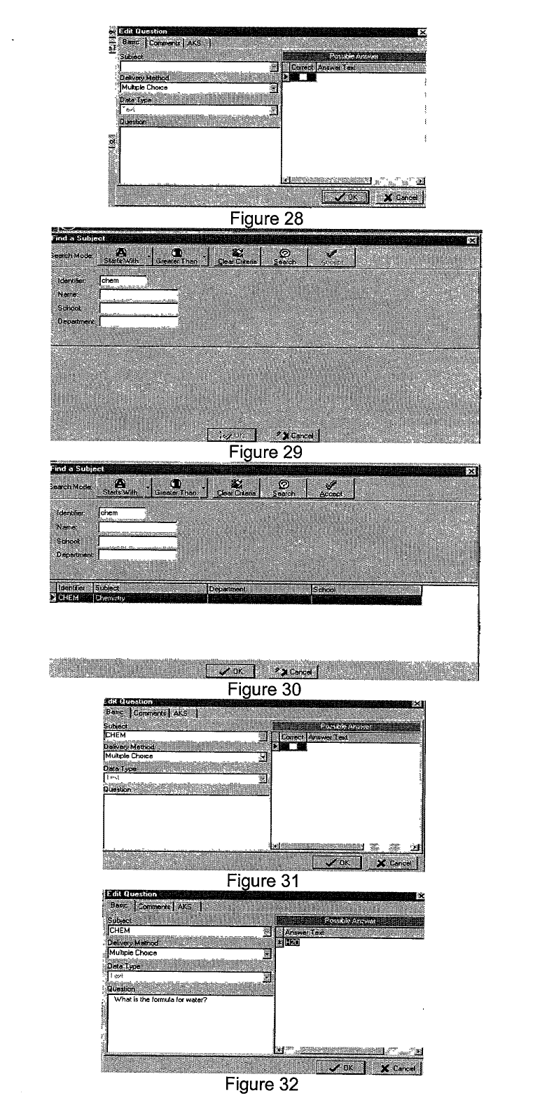

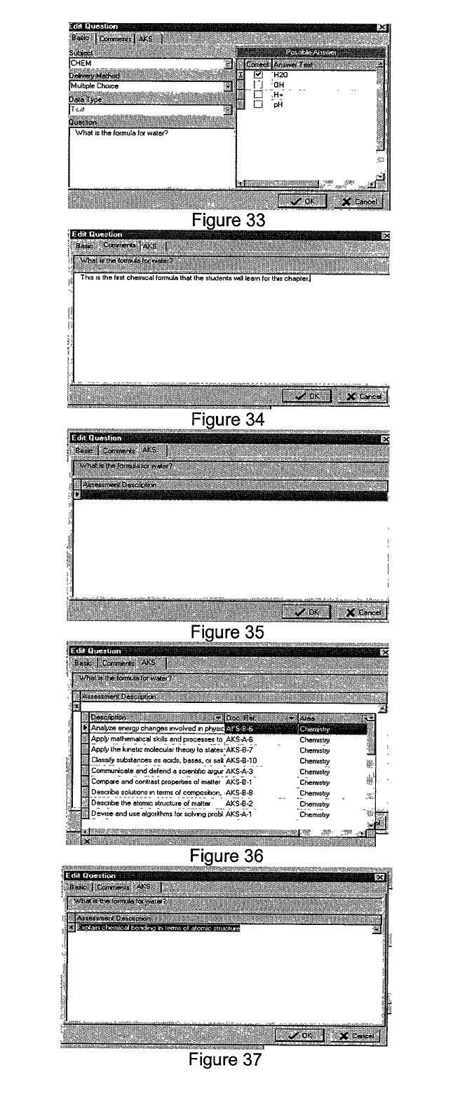

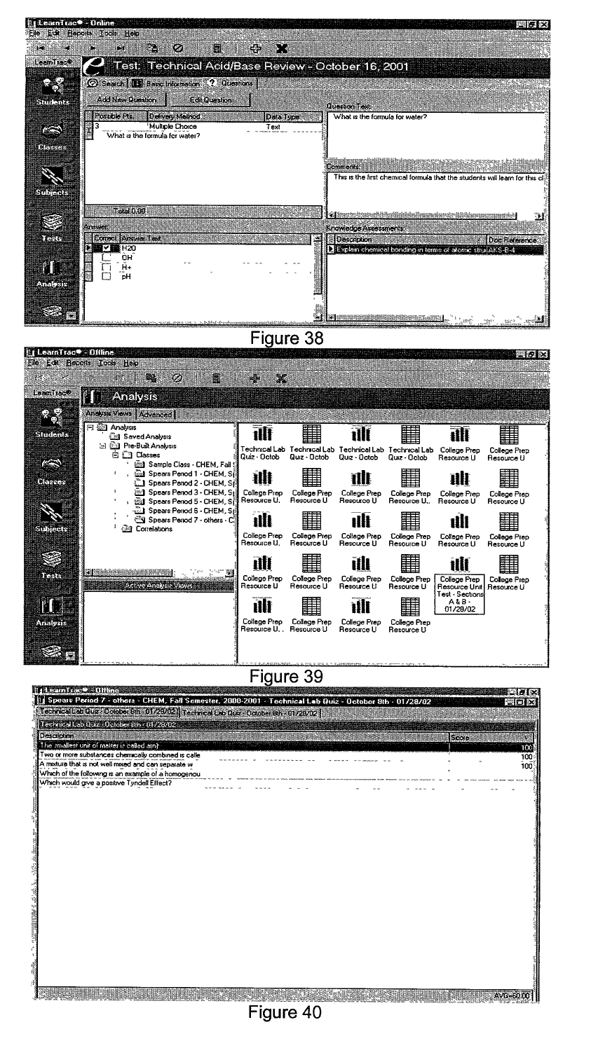

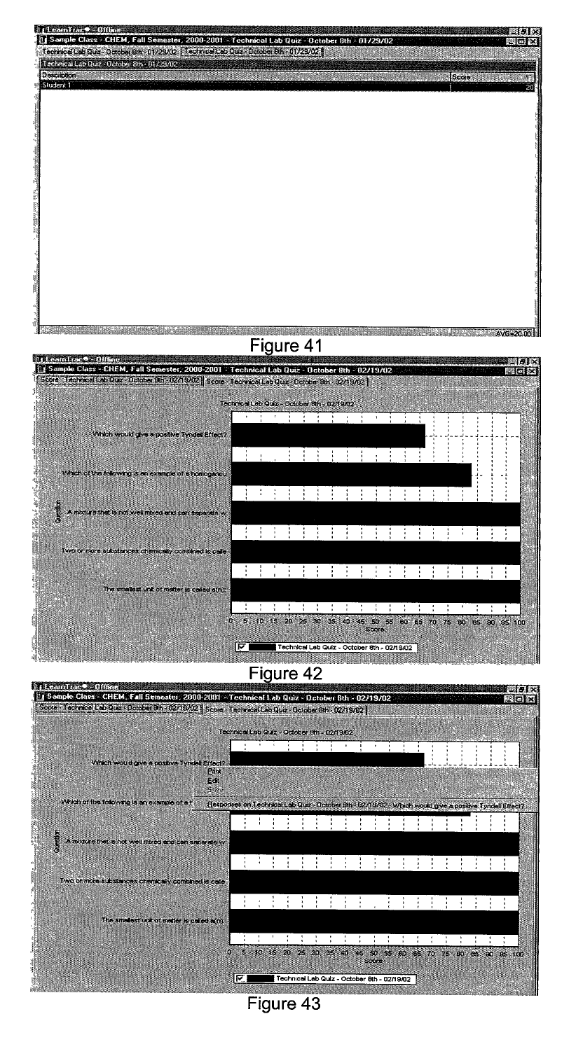

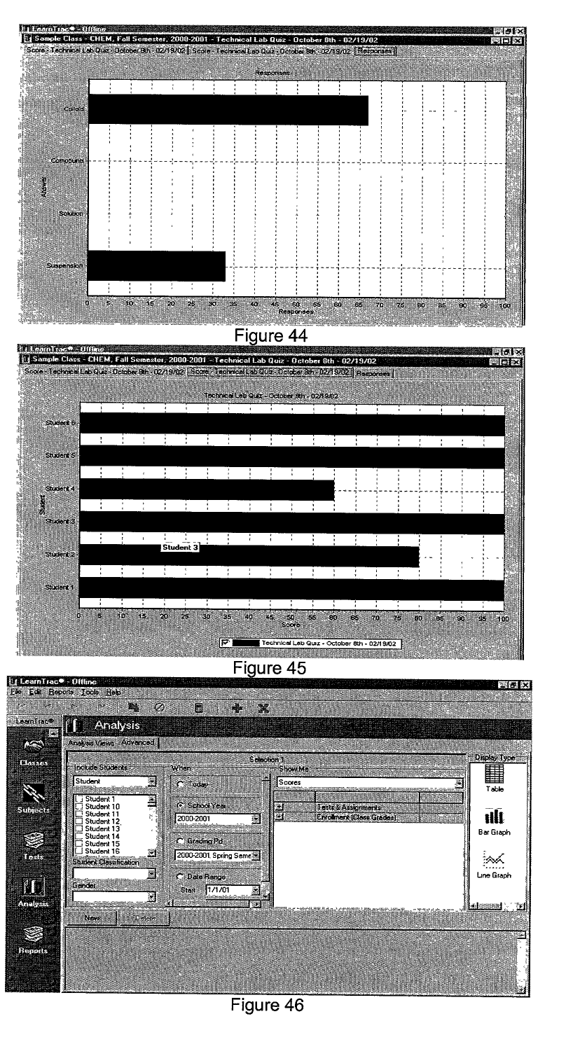

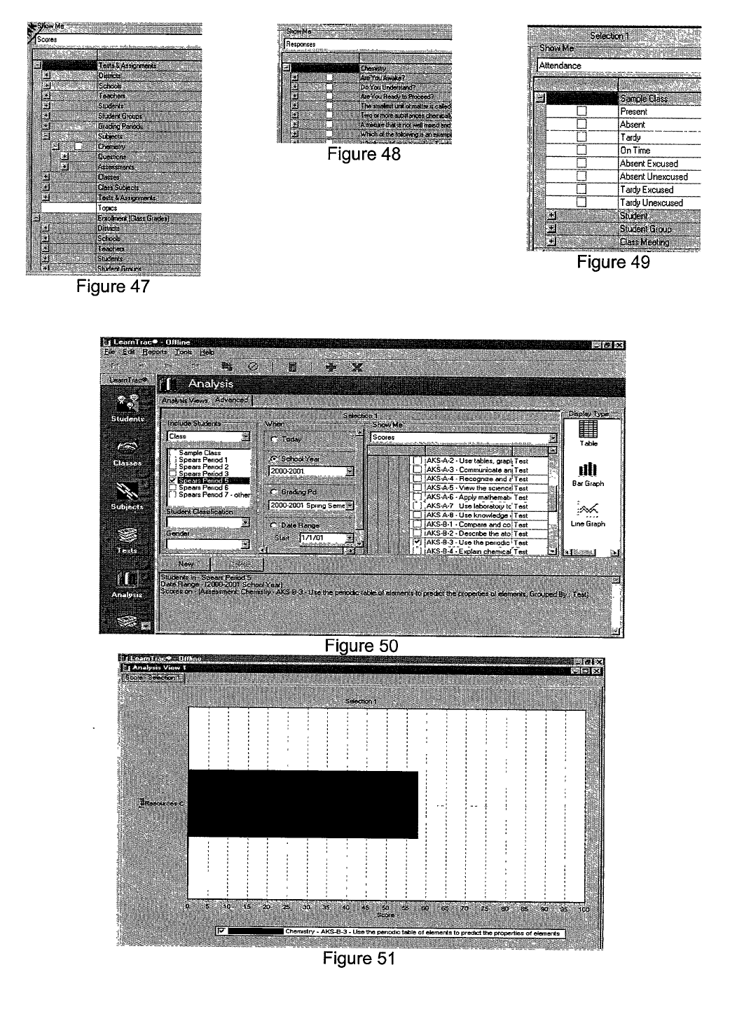

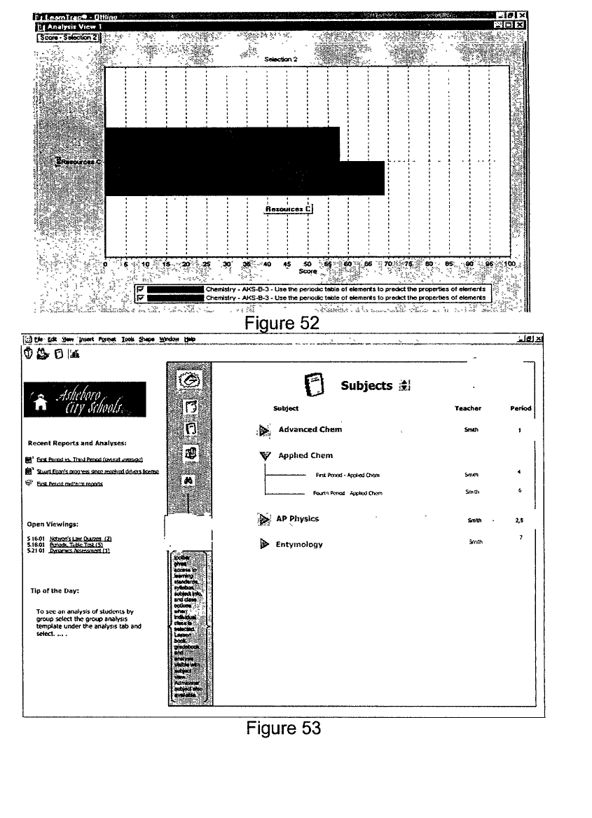

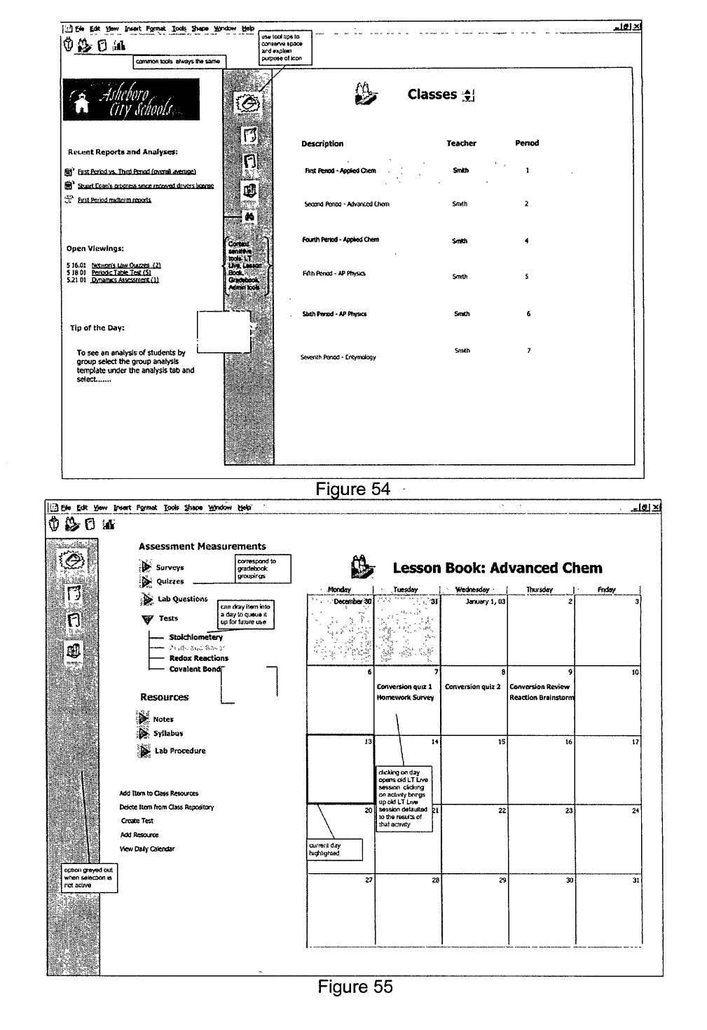

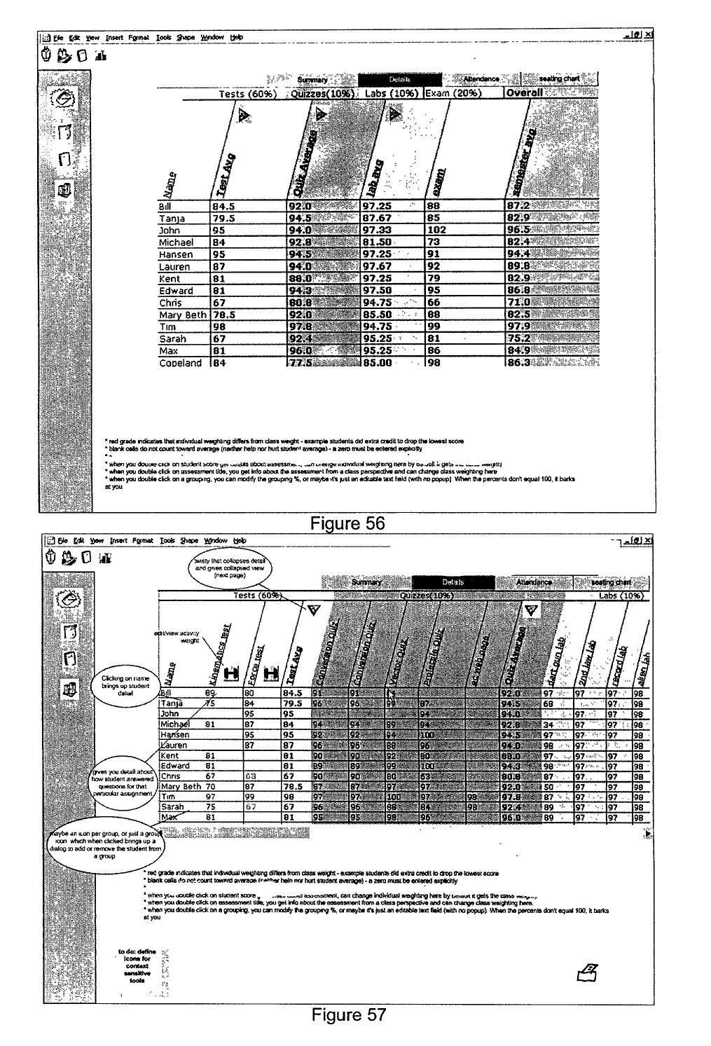

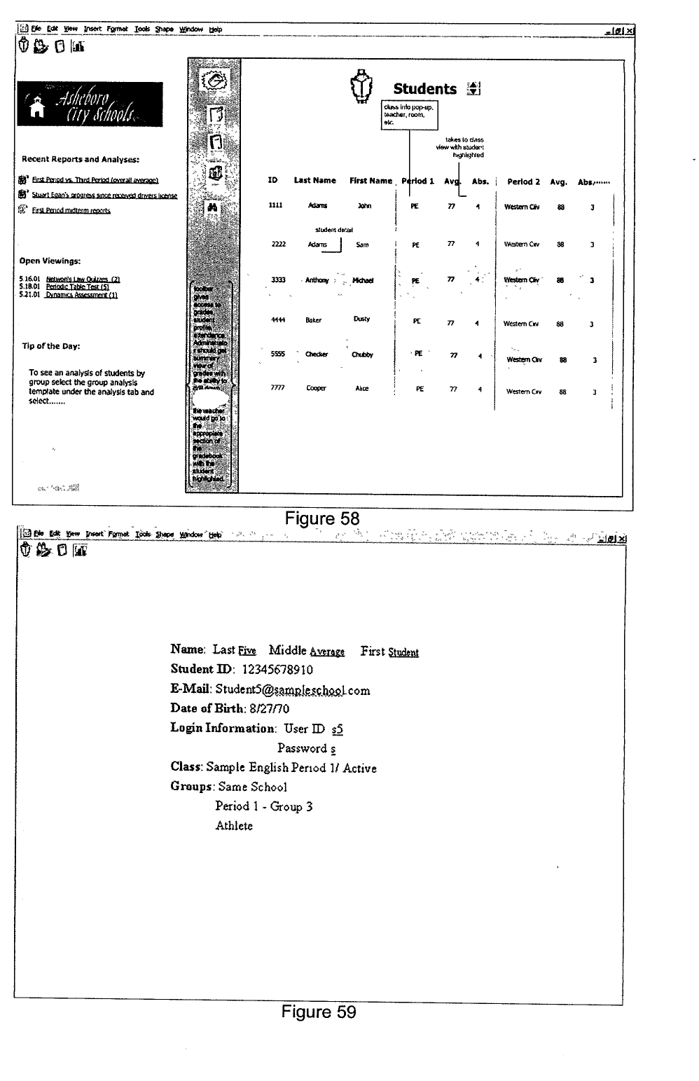

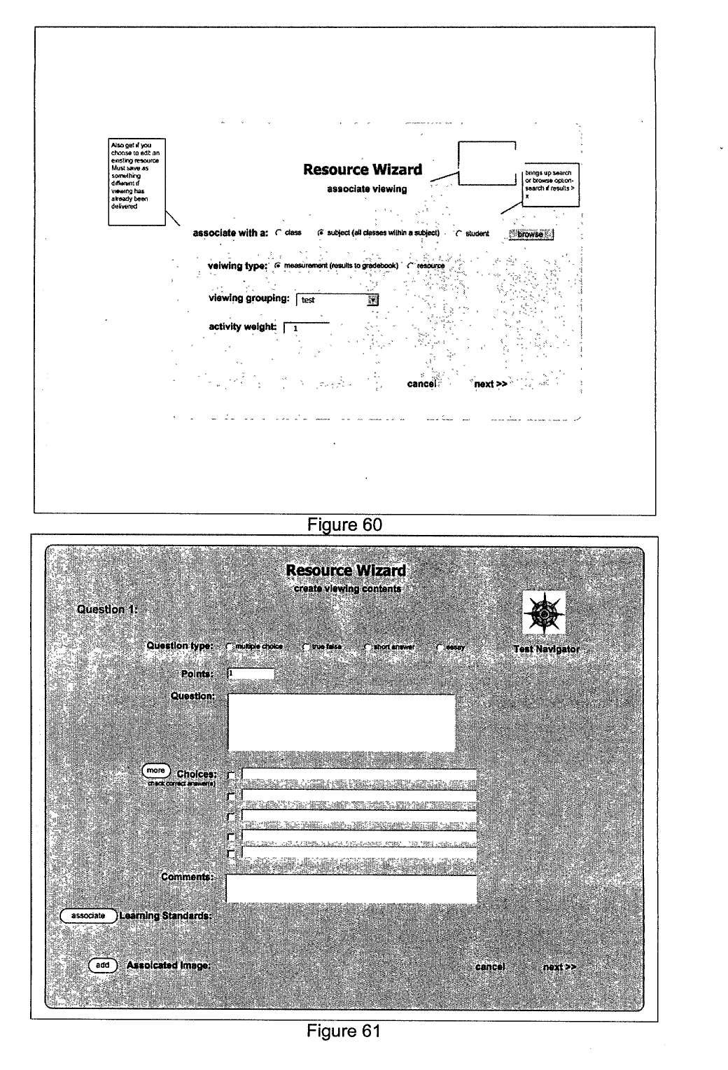

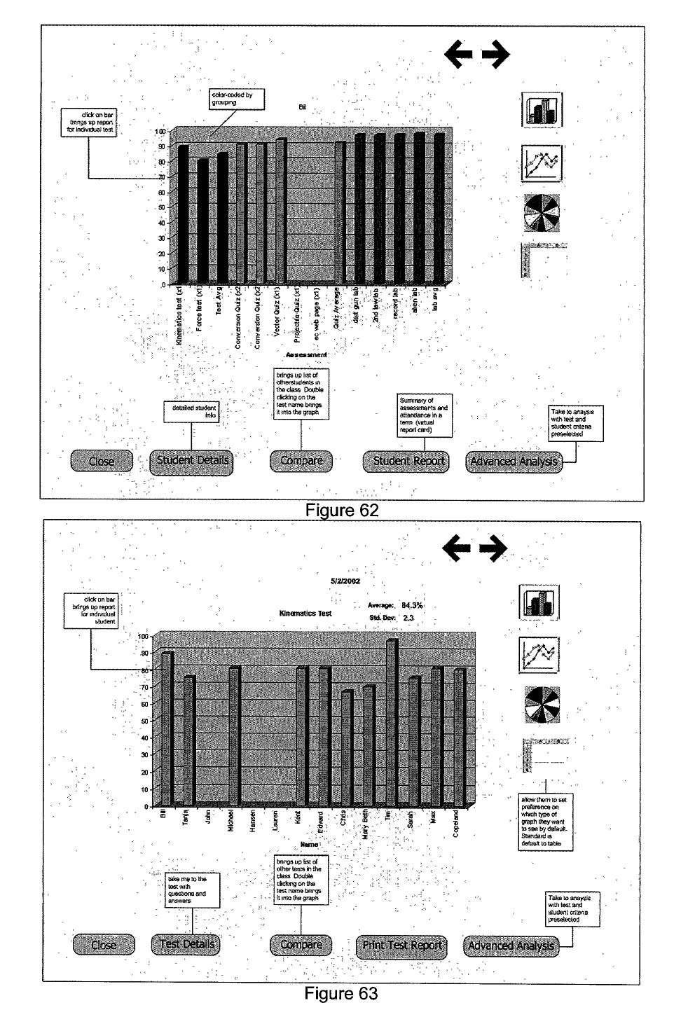

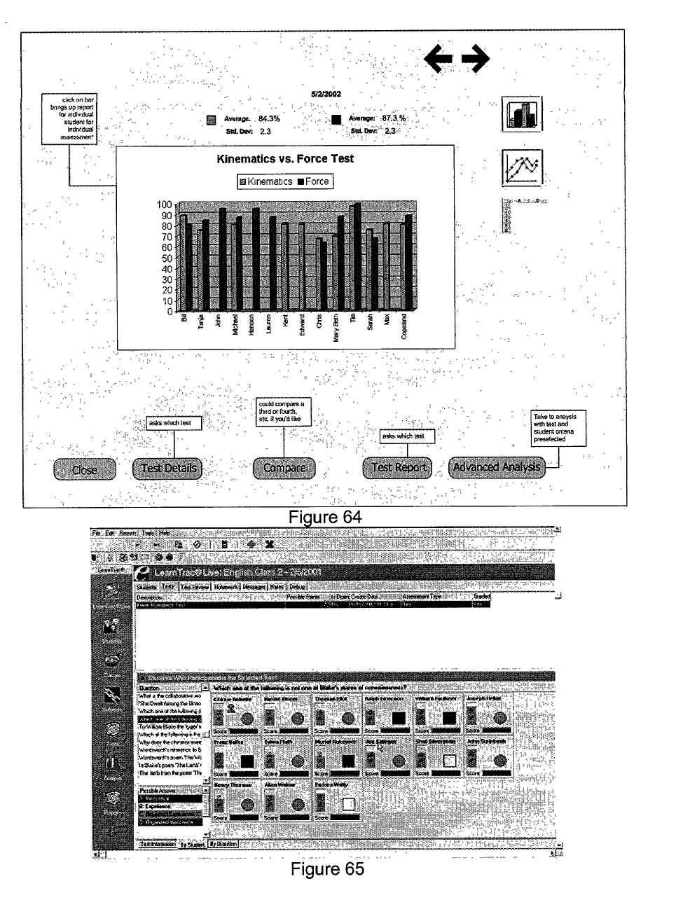

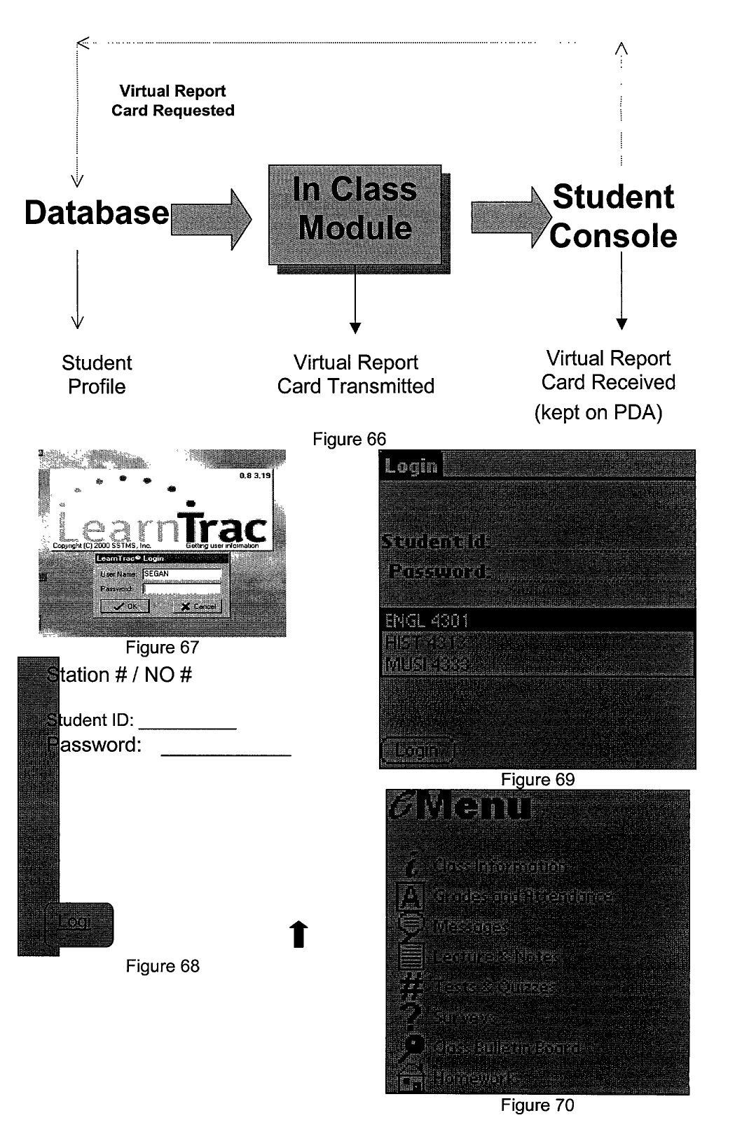

Another alternative embodiment is to include different access levels to the information within the database. Examples of different access levels include student, parents, teacher, department head, school administrative personnel, principals, and district level administrative personnel. The rationale for this is that a student does not need to see information about specific other students besides themselves, but general information regarding the overall class performance may be useful for them to know. The same holds true for the parents. A login like that shown in FIG. 67 can act as the mechanism to control the level of access.

Communications Server

FIGS. 1 and 2 illustrate an exemplary embodiment of the communications server.

The communications server preferably routes information flowing from the teacher console to the student consoles, the student consoles to the teacher console, the student console(s) to the database, the database to the student console(s). To assist in controlling the flow of information the communications server preferably includes a manager that preferably includes at least one event queue. More preferably, there are multiple event queues to handle different types of information and thus assign priority to the information based upon the type and source of the information.

The method for handling events by the manager and at least one event queue with respect to the student consoles during a class session preferably includes the following steps. The communications layer preferably performs its communications processing to see if any communications are being sent by the student consoles. If any messages are received, then preferably the messages are added to the appropriate queue such as tests, questions, and messages. The communications layer then preferably pulls the outgoing communications from the queues and sends them to the respective student consoles. An alternative embodiment adds a step of testing the communications link with the student consoles. The next step preferably is processing of the system events for student interaction. This step more preferably includes pulling any requested data from the database server and then sending the information via the queue and student console interface to the student console(s).

Student Console

As illustrated in FIG. 3, the student console preferably includes a user interface that allows the student to interact with system to further their education. To accomplish this objective, the user interface preferably is capable of performing a variety activities including logging into and out of the system, receiving information from the teacher console, requesting information from the database, requesting and/or sending information from/to the teacher console, exchanging homework information with the teacher console, obtaining syllabus and class schedule information, receiving assessments from the teacher console, and submitting completed assessments. Preferably, each of these activities is accomplished using appropriate methods.

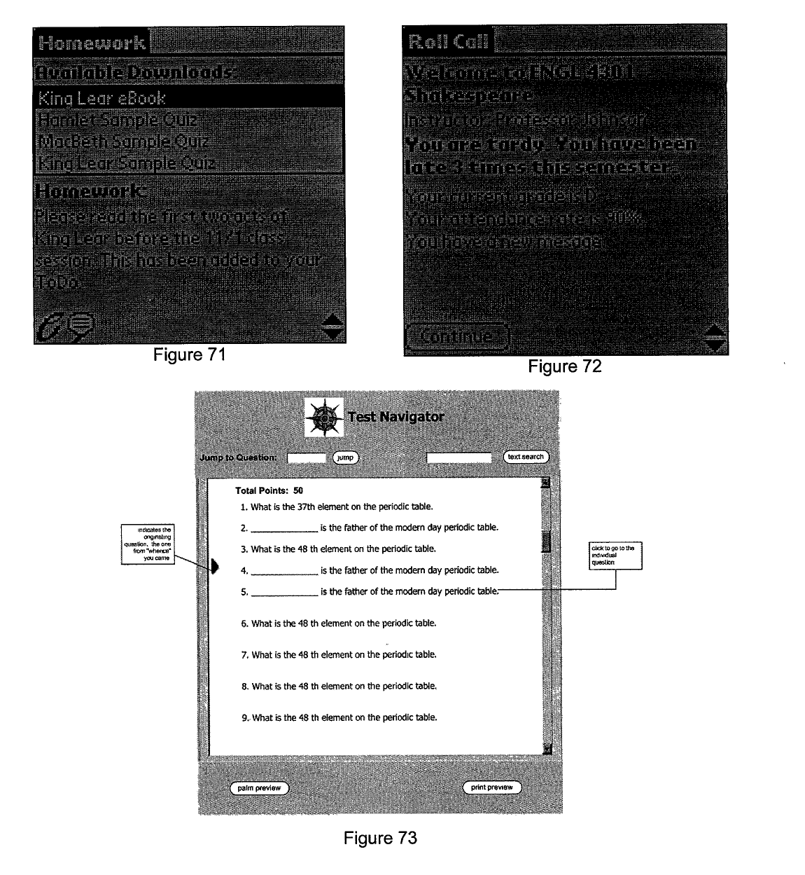

The preferred method for logging in includes the following steps after detecting the presence of a communications server. First, preferably prompting the student for a user login identification and password as illustrated in FIGS. 68 and 69. Next, receiving the user login identification and password from the student preferably by the user interface. Preferably, the user interface instructs the communications server interface to transmit the information to the communications server. Preferably, receiving an acknowledgement from the communications server that authenticates the user. Preferably, then the student will be provided a menu of options, an example of which is illustrated in FIG. 70. An alternative embodiment adds receiving a request for homework as part of the acknowledgement and then preferably transmitting any homework to the communications server. Another alternative embodiment checks for downloads as depicted in FIG. 71. A still further alternative embodiment provides a virtual roll call like depicted in FIG. 72.

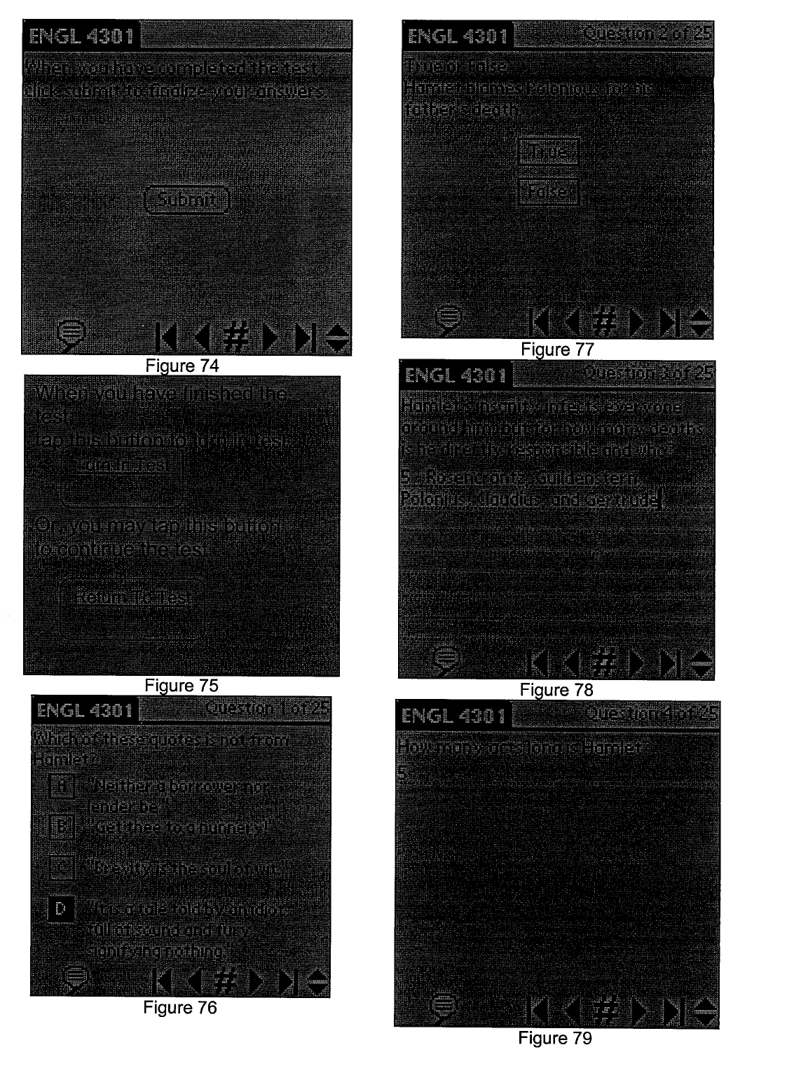

The preferred method for handling an assessment includes the following steps after receiving an assessment sent by the teacher console. Preferably, displaying the assessment such that if multiple questions are included as part of the assessment an interface like that illustrated in FIG. 73, which allows the student to move between questions. The display preferably will begin at the first question and/or the instructions for the assessment depending upon how the assessment was designed. Alternatively, the display could replicate a blank cover until an instruction is received to remove the blank cover from the top of the virtual assessment. Preferably, the next step is receiving an answer to a question from the student by the user interface. Alternatively, receiving an instruction to display another question is received from the student, when this occurs displaying the requested question and waiting for an answer. Then the user interface preferably instructs the communications server interface to transmit the answer to the communications server for relay preferably to the database and the teacher console. Preferably approximate to the forwarding of the answer, the user interface displays the next question for the assessment if there is at least one question remaining in the assessment. Approximate is used to include prior to, concurrently, or after another action. If there are no more questions left in the assessment, then user interface preferably inquires whether the student is finished with the assessment and wishes to submit all of the answers and receives an instruction from the student to return to a question or submit all of the answers FIGS. 74 and 75 provide examples of possible interfaces. The user interface preferably displays the requested question or has the communications server interface transmit notification that the student has finished the assessment. FIGS. 76-79 provide examples of how questions may be displayed to the students.

The preferable method for handling receipt of homework assignments is similar to that for receiving and handling assessments. The differences include that the homework preferably is connected off-line, i.e., not connected to the network and outside of class. Preferably, the communications server interface receives from the communications server a homework assignment. The communications server then preferably notifies the user interface that a homework assignment has been received. The user interface preferably notifies the student of receipt of the homework assignment, and alternatively the student console may make an entry in any scheduling software on the student console of the due date and/or other information for the homework to provide a reminder to the student. When the student wishes to begin the homework assignment, preferably receiving an instruction to that effect and displaying the homework assignment for completion including displaying the instructions, information, and/or questions and allowing the student to navigate through the homework similar to the navigation possible through an assessment. Alternatively, at the conclusion of the homework, requesting the student to acknowledge completion of the homework and allow submission of the homework upon the next connection to the system and/or attendance in the course that assigned the homework. Another alternative step may be to require the student to login prior to displaying the homework and accepting any student input in response to the homework. A further alternative embodiment would be that the teacher console would initiate the collection of the homework instead of the student console offering to turn in the homework. This process could be accomplished by the teacher console sending a request for any messages that were queued by the student console while it was not connected to the system.

In an alternative embodiment, the system allows a teacher to ask a question on-the-fly, i.e., a spontaneous question. The method for handling such a question preferably is similar to the method for handling assessments. The first step preferably is receiving the question from the communications server at the communications server interface, which preferably passes it to the user interface. The user interface preferably displays the question and prompts the student to answer the question. Alternatively, the prompt may include an audio component in addition to any visual component of the prompt. Once the student answers the question, receiving the answer by the user interface, passing the answer from the user interface to the communications server interface, and transmitting the answer to the communications server.

The preferable method for handling a message to be sent to the teacher includes the following steps. First, preferably displaying a user interface that includes a way for the student to indicate to the user interface that the student wishes to send a message to the teacher. Possible ways to accomplish this include displaying an icon or other link mechanism to call a routine to accomplish the following steps. Upon receiving an instruction from the student, preferably displaying an interface like that illustrated in FIG. 80 for entry of a message to be sent that also will includes a way for the student to indicate completion of the message. Preferably, the next step is receiving the completion indication by the user interface, which then relays the message to the communications server interface for transmission to the teacher console through the communications server. Preferably, the communications server transmits the message upon receiving it from the user interface.

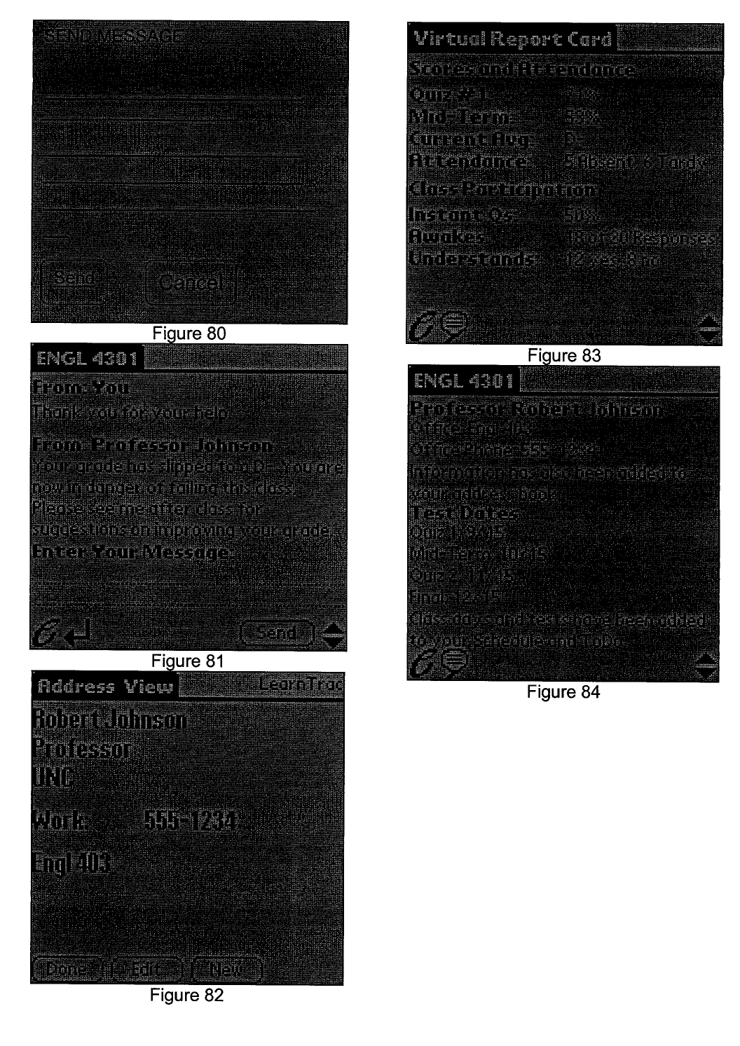

The preferable method for indicating the student wants to virtually raise his/her hand includes the following steps. First, preferably displaying a user interface that includes a way for the student to indicate that wish to the teacher. Possible ways to accomplish this include displaying an icon or other link mechanism to call a routine to accomplish the following steps. Upon receiving the instruction from the student by the user interface, preferably the user interface instructs the communications server interface to send the notification and then having the communications server interface transmit the notification to the communications server. FIG. 81 illustrates a reply message from the teacher console.

The method for requesting information from the database preferably includes the following steps. First, preferably displaying a user interface that includes a way for the student to indicate that wish to the teacher. Possible ways to accomplish this include displaying an icon or other link mechanism to call a routine to accomplish the following steps. Upon receiving the instruction from the student by the user interface, preferably the user interface instructs the communications server interface to send a request to the communications server to request for the information from the database. Alternatively, the user interface may request additional information to better focus the information being requested including possibly using a search module similar to that discussed above in connection to the teacher console. The next step of this method after transmitting the request preferably is receiving the requested information from the communications server. This step preferably includes passing the information from the communications server interface to the user interface. The user interface preferably notifies the student of the receipt of the information and/or displays the requested information. Preferably, the last step will wait if the student is currently in the process of completing an assessment or some other interaction with the system. FIGS. 82-84 illustrate examples of displayed information.

The preferred method for handling a message from the teacher includes the following steps. The first step preferably is receiving a message by the communications server interface from the communications server. Next, preferably passing the message from the communications server interface to the user interface. The user interface preferably determining priority for the message and timing of display to the student based upon any non-message information that accompanies the message. Displaying the message to student by the user interface. Alternatively, an audio cue may be provided by the user interface to the student.

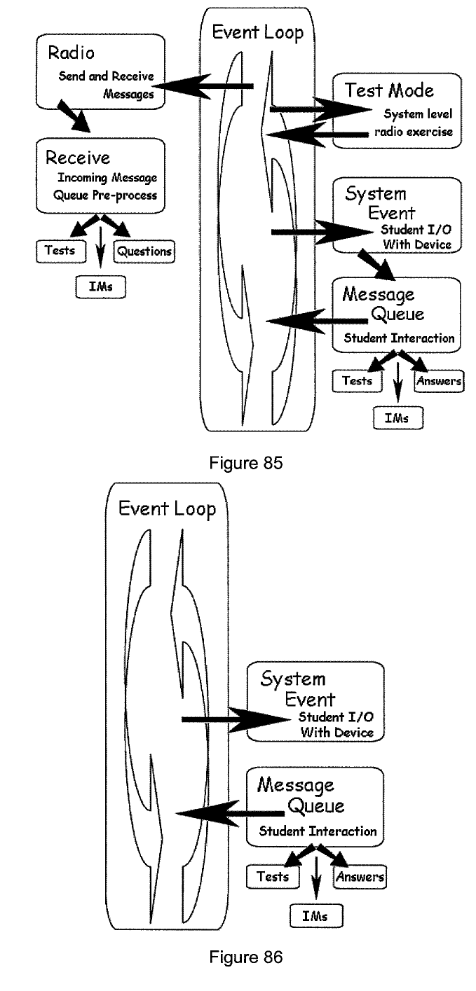

The preferred method for handling different events such as assessments and messages by the student consoles are illustrated in FIGS. 85 and 86 and as follows.

The method for handling events by the student console during a class session preferably includes the following steps and is depicted in FIG. 85. The communications server interface preferably performs its communications processing to see if any communications are being sent to the student consoles by the communications server. If any messages are received, then preferably the messages are added to the appropriate queue such as tests, questions, and messages. The communications server interface then preferably pulls the outgoing communications from the queues and sends them to the user interface. An alternative embodiment adds a step of testing the communications link with the communications server. The next step preferably is processing of the system events for student interaction. This step more preferably includes displaying the data based on the queue and collecting the information from the student with the information being sent back through the queue of the communications server interface to the communications server.

When the student console is offline, the event loop processing preferably performs much in the same manner except it deals only with message queues and is depicted in FIG. 86. Any information collected in the queues to be sent to the communications server is held until the student logs into the system at the beginning of any course and/or at the start of next session for the relevant class associated with the information being sent.

Database

Preferably, the database receives all information that originates from the student module, class module, subject module, and the test module. The test module feeds the information during the course of an assessment preferably based upon a key.

The database may also track the attendance record, the grade record, the discipline record, the ethnographic information, and medical information for a particular student. Preferably, the attendance record is automatically compiled based upon the student logging in for a class session; and more preferably, the attendance record includes what days the student was absent or tardy. The grade record also preferably is automatically kept based upon the assessments and homework completed by a student as that information is feed into the database directly and for questions that allow automatic grading based on a key those questions are graded. The database also can track the frequency of asking questions and responses to stimuli like on-the-fly questions and status checks such as are you awake. The database preferably also will contain any notes and/or comments compiled by teachers about a student. The student records also will preferably include the results from assessments. The database preferably will allow for analysis of which students are in which classes and which classes are taught by which teachers. Preferably, this will allow accessing information about a particular student based, for example, upon the student as an individual, a member of a class, a member of a grade, or a member of a school.

The information contained in the database dictates what data may be analyzed by the teacher.

Additional Alternative Embodiments

An alternative embodiment adds a web application to the system to allow interaction with the database of the system from, for example, over the Internet as illustrated in FIG. 87. The web application preferably includes means for providing security of the information being requested. The web application may be used by parents to insure that their children are present in class and check on how their children are performing in school or a particular course.

Another alternative embodiment of the invention is to include a submodule that monitors and tracks the attendance of students at class sessions. The monitoring may be accomplished through a predefined report that is set to run on a regular basis. If a student begins to miss to much class time, a warning will be sent to the in-class module to let the teacher know about the situation and a message will be sent to the student console to encourage better attendance by the student.

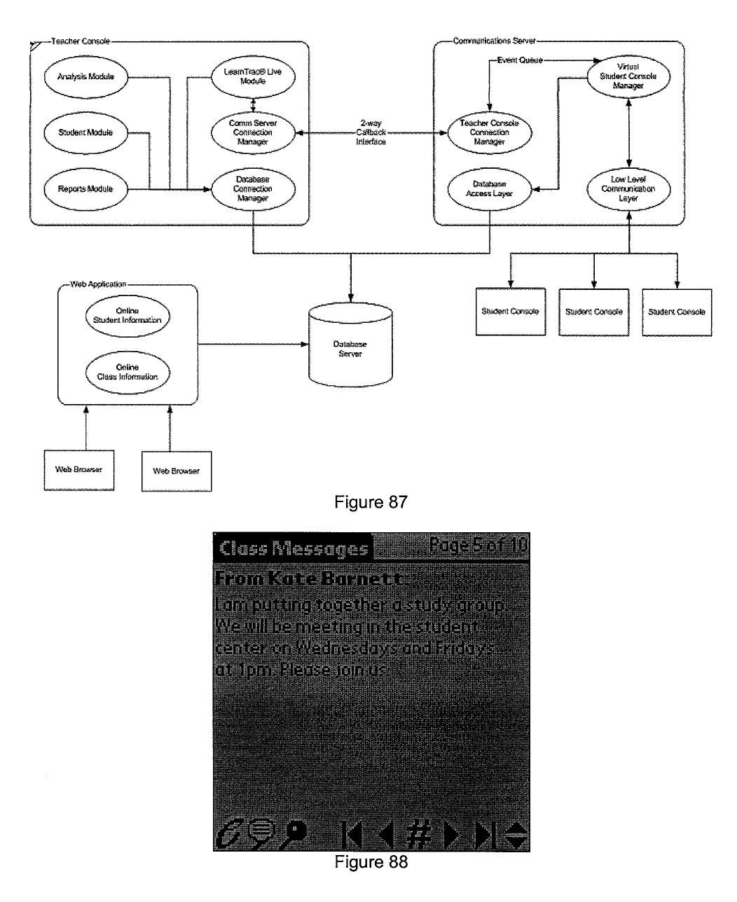

Another alternative embodiment of the invention is messaging between student consoles preferably at times other than when assessments are being conducted. The communications server preferably will route the message between student consoles based upon header information included within the message being sent. FIG. 88 illustrates an example of such a message.

The preferred and alternative embodiments described above may be combined in a variety of ways with each other. Furthermore, the data fields discussed above in the preferred and alternative embodiments may be contained and organized in other ways, and, more particularly, an alternative embodiment may be included with some of its particular set of describe data fields but not all of the data fields.

Although the present invention has been described in terms of particular preferred and alternative embodiments, it is not limited to those embodiments. Alternative embodiments, examples, and modifications which would still be encompassed by the invention may be made by those skilled in the art, particularly in light of the foregoing teachings.

Those skilled in the art will appreciate that various adaptations and modifications of the preferred and alternative embodiments described above can be configured without departing from the scope and spirit of the invention. Therefore, it is to be understood that, within the scope of the appended claims, the invention may be practiced other than as specifically described herein.

We claim:

1. A system for educating students comprising:
at least one teacher console,
at least one communications server connected to said at least one teacher console,
at least one student console capable of connection to said at least one communications server, and
a database in communication with said at least one teacher console and said at least one communications server.

2. The system according to claim 1, wherein at least one of said at least one communications server includes a wireless transmitter.

3. The system according to claim 1, wherein said at least one teacher console includes
at least one module,
at least one communications server interface in communication with said at least one module and one of said at least one communications server; and
wherein said at least one module includes means for assisting the education of students.

4. The system according to claim 1, wherein said at least one teacher console includes a class module, a subject module, a student module, a test module, an analysis module, a database connection interface, and a communications server interface.

5. The system according to claim 4, wherein said communications server interface includes an event router.

6. The system according to claim 1, wherein each of said at least one student console includes a server communications interface capable of communicating with said communications server and a user interface.

7. The system according to claim 1, wherein each of said at least one communications server includes a database interface and a manager having an event queue.

8. The system according to claim 1, further comprising at least one web application in communication with said database.

9. A method for educating students comprising:
requiring each student to login upon arrival for a class session,
sending assessments from a teacher workstation to at least one student via a network,
receiving at least one answer in response to a question included within the assessment while the student is completing the assessment,
tracking the answers entered by the at least one student such that the answers can be displayed upon request from the teacher, and
tracking the progression of each at least one student through the assessment such that the tracking information can be displayed upon request from the teacher.

10. The method according to claim 9, further comprising providing a breakdown of the collective answers for the at least one student.

11. The method according to claim 9, wherein the information regarding answers and tracking are provided graphically to the teacher.

12. The method according to claim 9, further comprising compiling the login of each student to build attendance record for each student.

13. The method according to claim 12, further comprising collating the attendance records for a particular student with the results from each assessment to determine whether there is a correlation between errors made on the assessment with material missed during absences from class.

14. The method according to claim 9, further comprising associating questions in each assessment with a respective learning standard.

15. The method according to claim 14, further comprising analyzing assessment results in terms of the learning standards.

16. A computer data signal embodied in a carrier wave readable by a computing system and encoding a computer program of instructions for executing a computer process performing the method recited in claim 9.

17. A computer-readable medium having computer-executable instructions for the method recited in claim 9.
